(19) United States
(12) Patent Application Publication
(10) Pub. No.: US 2026/0349118 A1
(43) Pub. Date: Nov. 5, 2026

(54) SYSTEMS, DEVICES, AND METHODS FOR RADIATION DETECTION

(71) Applicant: ams-OSRAM AG, Premstaetten (AT)

(72) Inventors: Harald ETSCHMAIER, Graz (AT); Anderson SINGULANI, Graz (AT); Roger STEADMAN BOOKER, Aachen (DE); Thomas FROEHLICH, Ottikon bei Kemptthal (CH)

(21) Appl. No.: 19/487,025

(22) PCT Filed: Oct. 10, 2024
(86) PCT No.: PCT/EP2024/078529

§ 371 Date: Nov. 24, 2025

(30) Foreign Application Priority Data
Oct. 19, 2023 (DE) 10 2023 128 738.9

(51) Int. Cl. G01T 1/16; G01T 1/24; G10K 15/04

(52) U.S. Cl. CPC G01T 1/1603; G01T 1/243; G01T 1/244; G10K 15/046

(57) ABSTRACT

A radiation detector system includes a radiation absorber structure configured to generate acoustic waves in response to received radiation; one or more photonic integrated circuits arranged below the absorber structure; an optical waveguide extending adjacent to the one or more photonic integrated circuits; a light source configured to emit light into the optical waveguide; and a plurality of light sensors coupled to the waveguide. The photonic integrated circuits are configured to interfere with light in the optical waveguide in response to receiving acoustic waves from the radiation absorber structure.

### CROSS-REFERENCE TO RELATED APPLICATIONS

This application is a national phase of International Application No. PCT/EP2024/078529 filed on Oct. 10, 2024, which claims priority to German Patent Application No. 10 2023 128 738.9, which was filed on Oct. 19, 2023, the entire contents of both of which are incorporated herein by reference.

### FIELD

This present disclosure generally relates to radiation detection.

### BACKGROUND

Conventional X-ray detectors use scintillators to convert high energy X-ray photons X-rays to visible light, which then can be converted to an electrical signal by silicon based photodiodes.

These scintillators are made from exotic materials (e.g. Gadolinium oxysulfide) which are expensive to manufacture and difficult to handle in module assembly (i.e. they are very fragile and sensitive to heat).

FIG. 1 shows an illustration of a known X-ray detector system 100. The system 100 includes an X-ray source 110 which can generate X-ray beams 120. In particular, the x-ray source 110 is configured to generate x-ray beams toward a target 130 and an x-ray detector 140. The X-ray detector 140 converts received x-ray beams into optical photons. The x-ray detector includes use of a scintillator 142 or scintillator element to convert the received x-rays beams or x-ray radiation into (visible) light. The optical photons are then converted into electric current or electrical signals by the photodiodes of the photodiode layer 144.

The substrate 146 can keep the structure x-ray detector 140 flat and transfer the electrical current or electrical signals generated by the photodiode layer 144 to analog circuitry. For example, the analog circuitry can amplify and digitize the signal and send to further circuitry to generate images. The analog circuitry for amplifying and digitizing the generated signals may reside and be integrated within the substrate 146.

Experimental X-ray detectors include photoacoustic systems detect the acoustic waves generated by the target itself.

FIG. 2 shows an illustration of a known X-ray detector system 200 that uses photoacoustic signals. The system 200 includes an X-ray source 210 which can generate X-ray radiation 220 toward the target 230. The target 230 is required to be immersed in a liquid 235, which is not practical for many applications. The ultrasonic signals 237 generated in the liquid 235 can be detected by ultrasound detector array 240

However, in this type of approach, the X-ray source 210 is required to be a high frequency pulsed X-ray source, such as a linear accelerator. This is a very expensive and bulky X-ray source and thus not practical to be used in most (e.g. medical) applications.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosure. In the following description, various aspects of the disclosure are described with reference to the following drawings, in which:

FIG. 1 shows an illustration of known X-ray detection system;

FIG. 2 shows an illustration of a known X-ray detector system;

FIGS. 3A and 3B respectively shows a cross-sectional view and an overhead view of a radiation detection system according to aspects of the present disclosure;

FIG. 4 shows a flow diagram of a method according to aspects of the present disclosure; and

FIG. 5 shows a flow diagram of a method according to aspects of the present disclosure.

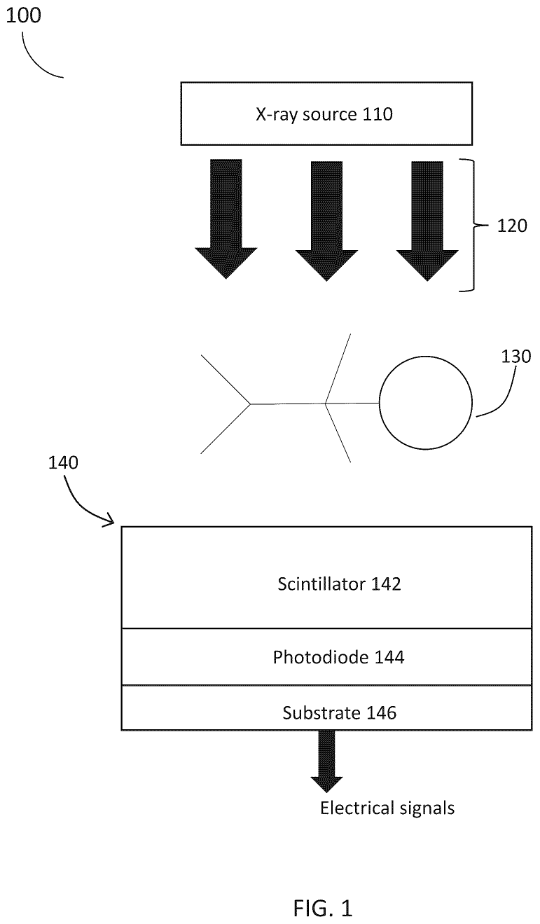

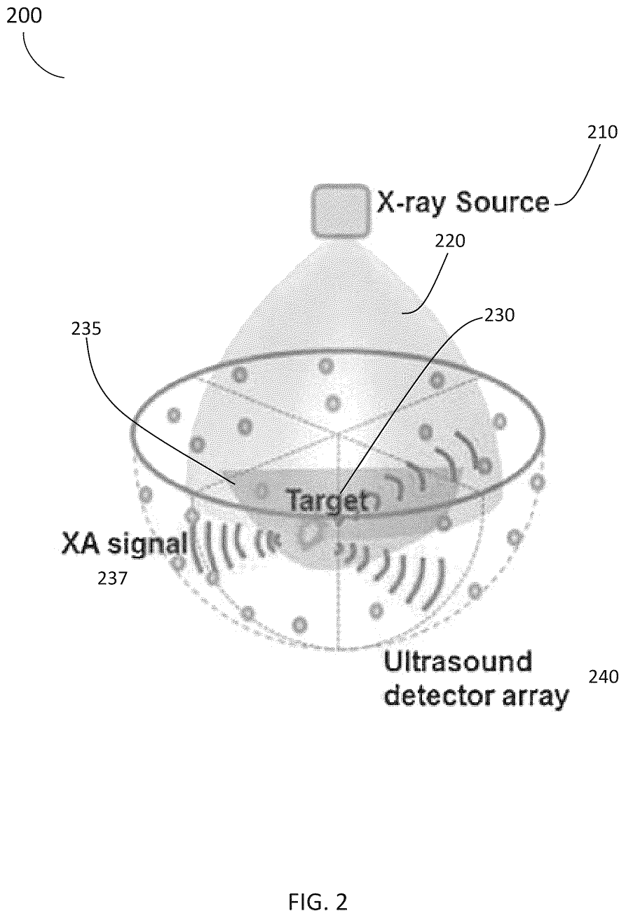

### DETAILED DESCRIPTION

The following detailed description refers to the accompanying drawings that show, by way of illustration, specific details and aspects in which the disclosure may be practiced. One or more aspects are described in sufficient detail to enable those skilled in the art to practice the disclosure. Other aspects may be utilized and structural, logical, and electrical changes may be made without departing from the scope of the disclosure. The various aspects described herein are not necessarily mutually exclusive, as some aspects can be combined with one or more other aspects to form new aspects. Various aspects are described in connection with methods and various aspects are described in connection with devices. However, it may be understood that aspects described in connection with methods may similarly apply to the devices, and vice versa. Throughout the drawings, it should be noted that like reference numbers are used to depict the same or similar elements, features, and structures. Throughout the drawings, it should be noted that proportions are not necessary to scale and that the size of features may be emphasized for ease of illustration.

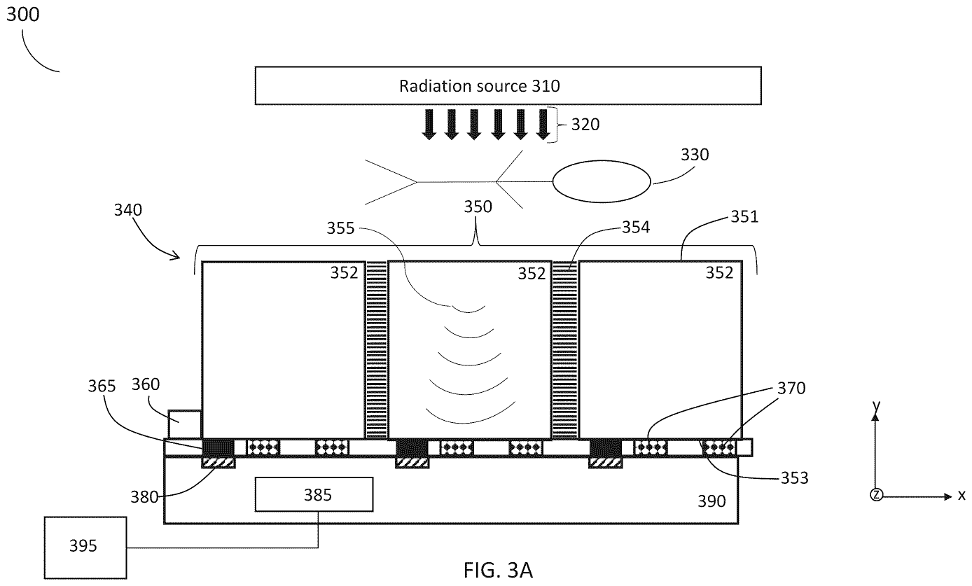

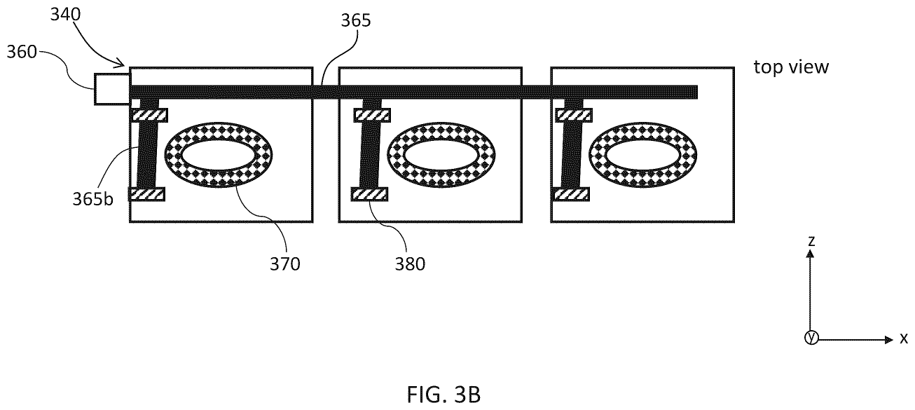

FIG. 3 shows a radiation detection system 300 according to aspects of the present disclosure.

The radiation detection system 300 (or simply system 300) includes a radiation source 310 that is configured to generate radiation 320. In at least one example, the radiation source 310 is an X-ray source that is configured generate X-ray radiation or X-ray beams. The X-ray source 310 does not need to be high frequency X-ray source such as a linear accelerator.

In particular, the radiation source 310 is configured to generate radiation 320 towards a target 330. The target 330 can be a body, such as a human body. In systems such as system 300, the target 330 does not need to be immersed in a liquid. That is, the target can be free from liquid immersion.

In the example of FIG. 3, the system 300 further includes a radiation detector 340. The radiation detector 340 can include a radiation absorber structure 350. In embodiments herein, the radiation absorber structure 350 is a structure configured to generate acoustic waves in response to received radiation. The received radiation can be radiation (e.g., X-rays) that have passed through the target 330. The radiation absorber structure 350 may be made or include any suitable material that can produce acoustic shock waves or acoustics waves in response to incident or received radiation.

In at least one example, the radiation absorber structure 350 can be configured to generate acoustic waves or acoustic shock waves in response to received X-rays X-ray photons.

According to at least the example of FIGS. 3A and 3B, the radiation absorption structure includes or be in the form one or more discrete radiation absorption slabs 352. The slabs 352 can be radiation absorption material in the form of rectangular blocks or any other suitable 3D shape (e.g., cylindrical shape) shape that generates acoustic signals or acoustic shock waves 355 in response to received radiation.

FIGS. 3A AND 3B shows multiple slabs 352 arranged linearly or along one-dimension, e.g., along the x-direction. However, in other examples, the multiple slabs 352 may be arranged as a 2-D array, e.g., M×N array (m columns, n rows), for example in a xz-plane as shown in FIG. 3A. Other configurations or types of may also be realized, such as, for example, circular arrays, spherical arrays, etc.

For example, for a sample to generate a strong acoustic signal in response to received x-ray radiation (e.g., x-ray pulses/x-ray photons/x-ray beams), pressure must build up in the sample faster than it can propagate away for the duration of the acoustic excitation. This condition is known as stress confinement and it is met so long as the duration of the x-ray pulse t_{L}, is sufficiently small such that t_{L}<d_{c}/vₛ where d_{c} is the characteristic length of heat heterogeneity in the sample (typically this is the desired resolution). The initial pressure generated in the sample from an x-ray pulse depends on the dimensionless Gruenesian parameter, Γ, of the sample at a given point, as well as the x-ray volumetric energy absorption (defined as energy absorbed per unit volume), A, of said sample. The initial pressure for a delta function excitation can then be written as p₀=ΓA. (From Samant et al., X-ray induced acoustic computed tomography, Photoacoustics 19, 2020).

In the case where the radiation absorber structure 350 includes slabs 352, each slab can be considered as a “pixel” of the radiation detection system 300.

In aspects of the present disclosure, the radiation absorber structure 350 may be made out of Tungsten. In at least one example, the radiation absorber structure 350 or slabs 352 may be substantially made out of pure Tungsten W. In on example, each slab or pixel 352 of the radiation absorption structure 350 may have a first side or a receiving area 351 of 100×100 μm². The receiving area can be the side or face of the slab 352 facing or, said differently, the area facing the x-ray source, which can be orthogonal to incoming radiation as shown in FIG. 3A.

The absorption of a single X-ray photon in a 100×100 μm² pixel leads to a pressure of ~1 mPa. This is in an audible range and detectable by a photonic IC. A flux of 1 GPh/mm²s would correspond to one event per 100 ns on average. This is a speed which can be achieved in an integrated circuit

In the example where the radiation absorber structure includes slabs 352, the receiving area can be 100×100 μm² with a thickness depth (e.g., along y-direction or measured from first side 351 to a second side 353 of the slab 355) can be substantially 600 μm.

Table 1 below shows an example of properties of a slab or pixel 352 made out of Tungsten (W):

TABLE 1

| absorber thickness | 6.00E−04 | m |
|---|---|---|
| pixel area | 1.00E−04 | m |
| energy | 25 | keV |
| density W | 19.25 | g/cm2 |
| Grüneisen parameter | 1.7 | |
| keV | 1.60E−16J | |
| energy photon | 4.01E−15J | |
| Pressure required | 0.0011 | Pa |

In other examples, the radiation absorber structure 350 may be made out of other materials. Materials that may be used include, tungsten, lead, titanium mobydelium, or combinations thereof. In the case where other materials are used, the dimensions of the radiation absorber structure, in particular, the slabs 352 will be changed or adapted appropriately to allow for the detection of acoustic waves 355 generated in response to incoming radiation (e.g., x-ray photons).

In the case where there are multiple slabs 352, e.g., an array of slabs, material 354 may be included between the slabs 352. In general, any material or combination of materials with a greater acoustic impedance than the radiation absorber structure 350 may be inserted between the slabs 352.

In example, air, which can have a higher acoustic impedance than at least Tungsten, may be included between the slabs 352. The higher acoustic impedance material 354 can serve the purpose of reducing cross-talk and acoustic interference between the slabs.

For example, the material 354 can help ensure acoustic waves 355 generated by slab are substantially transferred to a corresponding photonic integrated circuit and reduces the or mitigates any potentially cross-talk, e.g., acoustic waves from one slab 352 transmitting to another slab 352 or to a non-corresponding photonic integrated circuit. In short, the material 354 serves to acoustically isolate a slab from the other slabs or pixels.

While in embodiments each discrete slab 352 can have a corresponding photonic integrated circuit 370, this is not necessarily so. In some embodiments, where there are multiple slabs 352, two or more absorption slabs 352 can have a single corresponding photonic integrated circuit 370 or vice versa. For example, a single photonic integrated circuit 370 may be disposed or aligned below two different radiation absorption slabs 352.

Referring back to FIGS. 3A and 3B, the system 300 includes one or more photonic integrated circuits 370. Further, the system 300 also includes an optical or light waveguide 365. The optical waveguide 365 can extend horizontally (perpendicular to the vertical extension of the absorber slabs) so as to carry light.

In the example of FIGS. 3A and 3B, the optical waveguide 365 extends to be adjacent or in the vicinity of each of the one or more photonic integrated circuits 370.

The system 300 includes a light source 360. In the example of FIGS. 3A and 3B, the light source 360 is configured to emit light into the optical waveguide 365. The light source 360 may be any suitable type of light emitting device, such as, for example, a light-emitting diode (LED), a laser (e.g., a vertical-cavity surface-emitting laser), to name a few.

Further, the system 300 may include a plurality of light sensors. The system further includes light sensors 380. The light sensors 380 may be disposed adjacent or coupled to the optical waveguide 365. The optical waveguide 365 can carry the light from the light source 360 which then can be detected by the light sensors 380. In particular, the light sensors 380 may be arranged at certain positions next to the waveguide 365 and be able to detect when light in the optical waveguide arrives at those positions. The light sensors 380 can produce electrical signals based on the light it detects in the optical waveguide 365. The light sensors 380 may be any suitable type of light sensor and may be photodiodes, in one example.

In various embodiments, including FIGS. 3A and 3B, the one or more photonic integrated circuits 370 are arranged vertically below (along y-direction) from the radiation absorber structure 350. The photonic integrated circuits 370 are configured to detect acoustic waves 352 produced by the radiation absorber structure. In one or more examples, the photonic integrate circuits described herein may be or may include a photonic resonator ring.

In at least one example, a radiation absorber slab 352 may have a photonic integrated circuit 370 arranged directly below. Further, in the cases where there are multiple radiation absorber slabs 352, for each absorber slab 352, there can be a corresponding photonic integrated circuit 370 that is arranged or aligned directly below the radiation absorber slab 352. With this configuration, the radiation absorber slab 352 is configured to produce and emit acoustic waves to its corresponding photonic integrated circuit 370.

The photonic integrated circuits 370 e.g., photonic resonator rings, are highly sensitive to pressure variation of surrounding media (gases) and/or deformations. In the example of FIGS. 3A and 3B, the photonic integrated circuit 370 can detect the acoustic waves 355 from the radiation absorber structure 350. In response to detecting the acoustic waves 355, the photonic integrated circuits 370 can generate an electromagnetic radiation or produce an electromagnetic field that interferes with the light in the optical waveguide 365.

The light sensors 380 produce electrical signals light in response to light detected in the optical waveguide 365. As such, the light sensors 380 detect the light being interfered with by a photonic integrated circuit 370 and thus generate electrical signals corresponding to the detected interfered light.

As shown in FIGS. 3A and 3B, the optical waveguide 365 in radiation detection systems may include branches 365b. The branches 365b can split off from a main section or main trunk of the optical waveguide 365 so that each branch 365b can extend adjacent to a photonic integrated circuit 370. Further each branch 365b of the optical waveguide 365 may include a pair of light sensors 380 which, as previously explained, can generate electrical signals in response to detected light from the optical waveguide 365.

The light source 360, the optical waveguide 365, the one or more photonic integrated circuits 370, and the light sensors 380 may be mounted and/or integrated on a substrate 390. The substrate may be of any suitable material. For example, the substrate may be a semiconductor substrate, e.g., a silicon substrate or wafer. In one case, the radiation absorption structure 350 may be disposed on (e.g., directly or indirectly) on the one or more photonic integrated circuits 370 or disposed (directly or indirectly) on layer including the one or more photonic integrated circuits 370. The one or photonic integrated circuits 370 or the layer thereof may be disposed or mounted on the substrate 390.

In some cases, the electrical signals produced by the light sensors 380 may be processed by processing circuitry 385 in the substrate 390. That the circuitry 385 may, for example, amplify the electrical signals from the light sensors 380. Other circuitry may also be included. For example, the circuitry 385 may further include circuitry to digitize the electrical, such as after amplification.

In other cases, the electrical signals may be forwarded, with or without any processing, directly to processing circuitry 395 external to the radiation detector 340. The processing circuitry 340, which may be in the form of a computer, can be configured to process the signals (digital or analog) from the radiation detector 340 to generate digital images, e.g., digital images of the target.

Further, in some other instances, there may be one or more photonic integrated circuits 370 with no corresponding radiation absorption slab 352. Such photonic integrated circuits 370 may be used to provide a baseline comparison. That is, light sensor may produce electrical signals in response to light that may be interfered by this photonic integrated circuit 370. The signals produced by the corresponding light sensors 380 may be used as a part of differential approach for generating image. These light sensors 380 can produce electrical signals which can be used or processed along with electrical signals from other light sensors 380 described (e.g., light sensors 380 associated with photonic integrated circuits 370 that have corresponding radiation absorption slabs 352) to form a digital image of a target 330.

Unlike other x-ray detector or detection system, the system 300 does not need scintillators. That is, the system 300 can be free of any scintillators or scintillator material.

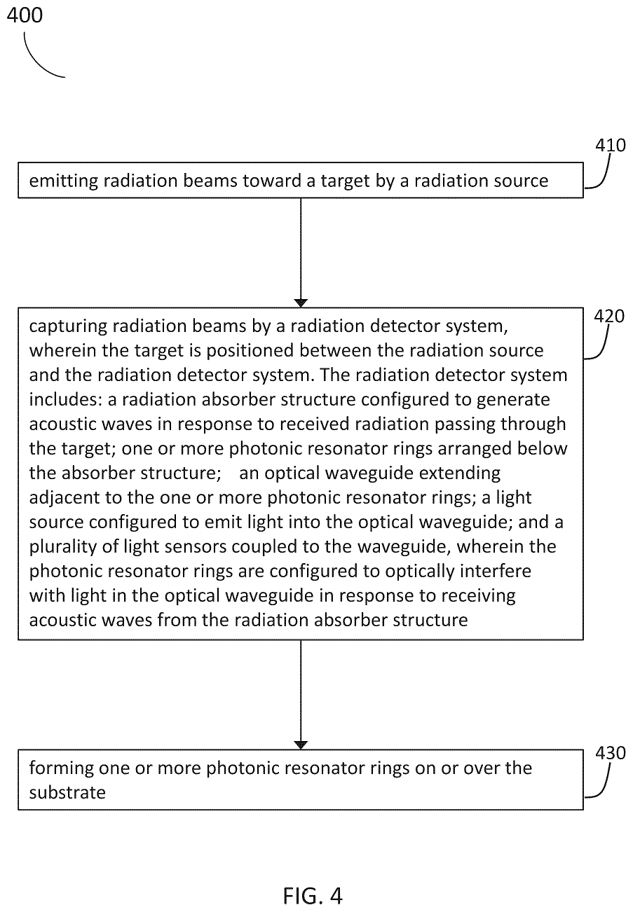

FIG. 4 shows a method 400. The method 400 includes at 410, emitting radiation beams toward a target by a radiation source. At 420, the method 400 includes capturing radiation beams by a radiation detector system, wherein the target is positioned between the radiation source and the radiation detector system. The radiation detector system includes: a radiation absorber structure configured to generate acoustic waves in response to received radiation passing through the target; one or more photonic integrated circuits arranged below the absorber structure; an optical waveguide extending adjacent to the one or more photonic integrated circuits; a light source configured to emit light into the optical waveguide; and a plurality of light sensors coupled to the waveguide. The photonic integrated circuits are configured to optically interfere with light in the optical waveguide in response to receiving acoustic waves from the radiation absorber structure.

The method 400 further includes at 430, processing electrical signals generated by the light sensors to generate a digital representation of at least a section of the target using processing circuitry coupled to the plurality of light sensors.

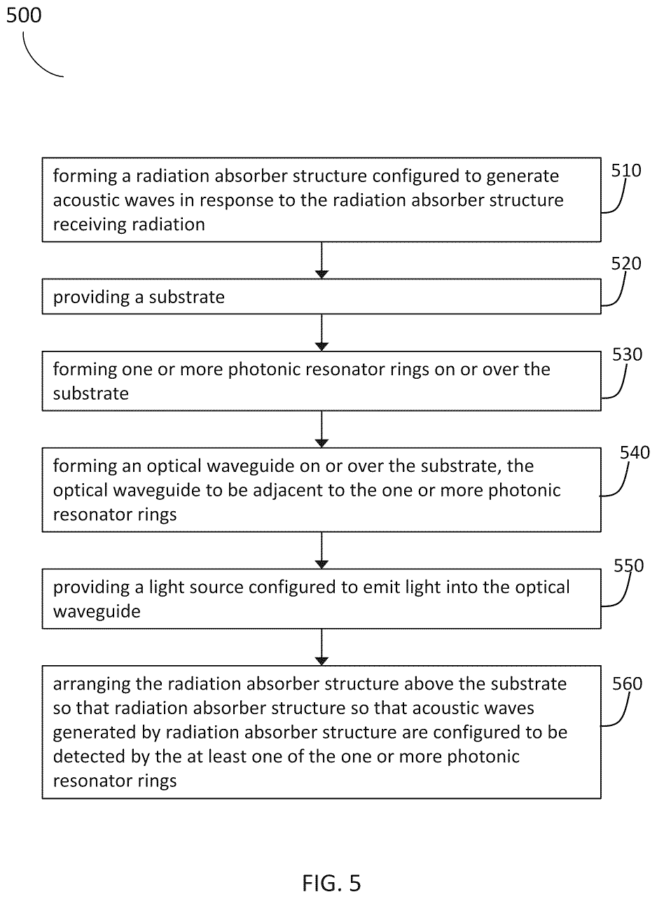

FIG. 5 is a method 500 for forming a radiation detection system. The method 500 includes, at 510, forming a radiation absorber structure configured to generate acoustic waves in response to the radiation absorber structure receiving radiation. At 520, the method 500 includes providing a substrate. At 530, the method includes forming one or more photonic integrated circuits on or over the substrate. At 540, the method includes forming an optical waveguide on or over the substrate, the optical waveguide to be adjacent to the one or more photonic integrated circuits. The method 500 at 550 includes providing a light source configured to emit light into the optical waveguide. At 560, the method 500 includes arranging the radiation absorber structure above the substrate so that radiation absorber structure so that acoustic waves generated by radiation absorber structure are configured to be detected by the at least one of the one or more photonic integrated circuits.

Conventional X-ray detectors make use of scintillators, which convert X-ray radiation to visible light, which then can be converted to an electrical signal by photodiodes. However, radiation (e.g., X-rays) detection systems or devices disclosed herein may use a different detection mechanism which does not require a scintillator. Other systems based on the photoacoustic effect detect the acoustic waves emitted directly from the target. However, the radiation detection systems and apparatus herein can convert and detect the radiation (e.g., X-rays) that have passed through a target (e.g., a human body or part thereof).

In aspects of the present disclosure, the radiation detection systems, devices, or methods can generate images of a target or generate portions of the target. In some examples, the digital representation or images (e.g., digital images) generated may be produced using computed tomography (CT). Said differently, the generated images of the target may be CT images, e.g., X-ray CT images.

Accordingly, the radiation sources (e.g., X-ray sources) described herein may be adapted to for the CT application. That is, the radiation source may be configured to generate radiation (e.g., X-rays) in multiple dimensions or planes. The corresponding radiation detector (e.g., the radiation absorption structures described herein may be situated or moved accordingly to detect radiation in corresponding different dimensions, locations, and/or planes.

In the following some examples are described, which relate to what is described herein and shown in the figures.

Example 1 is a radiation detector system including a radiation absorber structure configured to generate acoustic waves in response to received radiation; one or more photonic integrated circuits arranged below the absorber structure; an optical waveguide extending adjacent to the one or more photonic integrated circuits; a light source configured to emit light into the optical waveguide; and a plurality of light sensors coupled to the waveguide, wherein the photonic integrated circuits are configured to interfere with light in the optical waveguide in response to receiving acoustic waves from the radiation absorber structure.

Example 2 is the subject matter of Example 1 which may further include a radiation source operable to produce a radiation and toward a first side of the absorber structure.

Example 3 is the subject matter of Example 1 or 2, wherein the radiation source may be an x-ray source configured to produce x-ray beams towards the first side of the absorber structure, and wherein the radiation absorber structure may be configured to generate acoustic waves in response to receiving x-ray radiation produced from the x-ray source.

Example 4 is the subject matter of any of Examples 1 to 3, which may further include processing circuitry coupled to the plurality of light sensors and configured to process electrical signals produced by the plurality of light sensors.

Example 5 is the subject matter of any of Examples 1 to 4, wherein the radiation absorber structure may include a plurality of radiation absorber slabs.

Example 6 is the subject matter of Example 5, wherein the plurality of radiation absorber slabs may be separated by a material.

Example 7 is the subject matter of Example 6, wherein the material may have an acoustic impedance higher than an acoustic impedance of the radiation absorber slabs.

Example 8 is the subject matter of Example 6 or 7, wherein the material may include air.

Example 9 is the subject matter of any of Examples 5 to 8, wherein the one or more photonic integrated circuits may include a plurality of photonic integrated circuits.

Example 10 is the subject matter of Example 9, wherein each of the plurality of absorber slabs may respectively corresponds to one of the plurality of photonic integrated circuits so that for each absorber slab a corresponding photonic integrated circuit is aligned or arranged to be directly below the respective absorber slab.

Example 11 is the subject matter of Example 9 or 10, wherein for each of the plurality of photonic integrated circuits, a branch of the optical waveguide may extend adjacent thereto, wherein each branch can include a pair of the plurality of light sensors, and wherein each of the plurality photonic integrated circuits may be configured to interfere with light in the respective branch of the optical waveguide in response to receiving acoustic waves.

Example 12 is the subject matter of any of Examples 9 to 11, wherein at least one photonic integrated circuit of the plurality of photonic integrated circuits is arranged without any part of the absorber structure arranged directly above the at least one photonic integrated circuit.

Example 13 is the subject matter of any of Examples 1 to 12, wherein the radiation absorber structure may include or be made out of Tungsten.

Example 14 is the subject matter of Example 13, wherein the radiation absorber structure may be or made of substantially Tungsten.

Example 15 is the subject matter of any of Examples 1 to 12, wherein the radiation absorber structure may include lead.

Example 16 is the subject matter of any of Examples 1 to 12, wherein the radiation absorber structure may include titanium and/or molybdenum.

Example 17 is the subject matter of any of Examples 1 to 16, which may further include a substrate so that the absorber structure, the light source, and the one or more photonic integrated circuits are disposed on or above the substrate so that a second side of the absorber structure, opposite to the first side faces the substrate.

Example 18 is the subject matter of Example 17, wherein the substrate may be a semiconductor substrate.

Example 19 is the subject matter of Example 18, which may further include processing circuitry coupled to the plurality of light sensors and configured to process electrical signals produced by the plurality of light sensors to produce an image of a target.

Example 20 is the subject matter of Example 19, wherein the substrate may include the processing circuitry or a portion thereof.

Example 21 is the subject matter of Example 19 or 20, wherein the processing circuitry may be configured to generate the image of the target comprises the processing circuitry configured to generate a computer tomography (CT) image of the target.

Example 22 is the subject matter of any of Examples 1 to 21, wherein the light sensors may be photodiodes.

Example 23 is the subject matter of any of Examples 1 to 22, wherein the radiation detector system may not include any scintillator or scintillator material.

Example 24 is the subject matter of any of Examples 1 to 23, wherein the one or more the photonic integrated circuits may include one or more photonic resonator rings.

Example 1A is a method for forming a radiation detection system, the method including: forming a radiation absorber structure configured to generate acoustic waves in response to the radiation absorber structure receiving radiation; providing a substrate; forming one or more photonic integrated circuits on the substrate; forming an optical waveguide on the substrate to be adjacent to the one or more photonic integrated circuits; providing a light source so that light source is configured to emit light into the optical waveguide; arranging the radiation absorber structure above the substrate so that radiation absorber structure so that acoustic waves generated by radiation absorber structure are configured to be detected by the at least one of the one or more photonic integrated circuits.

Example 2A is the subject matter of Example 1A, wherein forming the radiation absorber structure may include patterning a radiation absorber material to form the radiation absorber structure.

Example 3A is the subject matter of Example 2A, wherein patterning the radiation absorber material may include laser sintering the radiation absorber material.

Example 4A is the subject matter of Example 2A, wherein patterning the radiation absorber material may include etching the radiation absorber material.

Example 5A is the subject matter of Example 1A, wherein forming the radiation absorber structure may include electroplating.

Example 6A is the subject matter of any of Examples 1A to 5A, wherein forming the radiation absorber structure may include forming a plurality of radiation absorber slabs.

Example 7A is the subject matter of Example 6A, wherein the plurality of radiation absorber slabs may be separated by a material having a higher acoustic impedance than the radiation absorber slabs.

Example 8A is the subject matter of Example 7A, wherein the material may include air.

Example 9A is the subject matter of any of Examples 1A to 8A, wherein the radiation absorber structure may include tungsten.

Example 10A is the subject matter of any of Examples 1A to 8A, wherein the radiation absorber structure may include lead.

Example 11A is the subject matter of any of Examples 1A to 8A, wherein the radiation absorber structure may include titanium and/or molybdenum.

Example 12A is the subject matter of any of Examples 1A to 11A, wherein the one or more photonic integrated circuits may include a plurality of photonic integrated circuits, and wherein for each of the plurality of photonic integrated circuits, a branch of the optical waveguide extends adjacent thereto, each branch including a pair of the plurality of light sensors, and wherein each of the plurality of photonic integrated circuits is configured to interfere with light in the respective branch of the optical waveguide in response to receiving acoustic waves.

Example 13A is the subject matter of any of Examples 1A to 12A, wherein the one or more the photonic integrated circuits may include or may be one or more photonic resonator rings.

Example 1B is a method including emitting radiation beams toward a target by a radiation source; capturing radiation beams by a radiation detector system, wherein the target is positioned between the radiation source and the radiation detector system, the radiation detector system comprising:
a radiation absorber structure configured to generate acoustic waves in response to received radiation; one or more photonic integrated circuits arranged below the absorber structure; an optical waveguide extending adjacent to the one or more photonic integrated circuits; a light source configured to emit light into the optical waveguide; and a plurality of light sensors coupled to the waveguide, wherein the photonic integrated circuits are configured to optically interfere with light in the optical waveguide in response to receiving acoustic waves from the radiation absorber structure; and processing electrical signals generated by the light sensors to generate a digital representation of at least a section of the target using processing circuitry coupled to the plurality of light sensors.

Example 2B is the subject matter of Example 1B, wherein the radiation source may be an x-ray source configured to produce x-ray beams, and wherein the absorber structure may be configured to generate acoustic waves in response to received x-ray radiation.

Example 3B is the subject matter of Example 1B or 2B, wherein processing electrical signals generated by the light sensors to generate a digital representation of at least a section of the target may include using processing circuitry to generate a computed tomography (CT) image of the target.

Example 4B is the subject matter of any of Examples 1B to 3B, wherein the one or more the photonic integrated circuits may include one or more photonic resonator rings.

The word “exemplary” is used herein to mean “serving as an example, instance, or illustration.” Any example or design described herein as “exemplary” is not necessarily to be construed as preferred or advantageous over other examples or designs.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

The words “plurality” and “multiple” in the description or the claims expressly refer to a quantity greater than one. The terms “group (of)”, “set [of]”, “collection (of)”, “series (of)”, “sequence (of)”, “grouping (of)”, etc., and the like in the description or in the claims refer to a quantity equal to or greater than one, i.e. one or more. Any term expressed in plural form that does not expressly state “plurality” or “multiple” likewise refers to a quantity equal to or greater than one.

The term “connected” can be understood in the sense of a (e.g. mechanical, optical and/or electrical), e.g. direct or indirect, connection and/or interaction. For example, several elements can be connected together mechanically such that they are physically retained (e.g., a plug connected to a socket) and electrically such that they have an electrically conductive path (e.g., signal paths exist along a communicative chain).

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

As utilized herein, terms “module”, “component,” “system,” “circuit,” “element,” “slice,” “circuitry,” and the like are intended to refer to a set of one or more electronic components, a computer-related entity, hardware, software (e.g., in execution), and/or firmware. For example, circuitry or a similar term can be a processor, a process running on a processor, a controller, an object, an executable program, a storage device, and/or a computer with a processing device. By way of illustration, an application running on a server and the server can also be circuitry. One or more circuits can reside within the same circuitry, and circuitry can be localized on one computer and/or distributed between two or more computers. A set of elements or a set of other circuits can be described herein, in which the term “set” can be interpreted as “one or more.”

Such electric or electronic circuitry can be operated by a software application or a firmware application executed by one or more processors. The one or more processors can be internal or external to the apparatus and can execute at least a part of the software or firmware application. As yet another example, circuitry can be an apparatus that provides specific functionality through electronic components without mechanical parts; the electronic components can include one or more processors therein to execute executable instructions stored in computer readable storage medium and/or firmware that confer(s), at least in part, the functionality of the electronic components. As another example, circuitry or similar term can be implemented in hardware such as application specific integrated circuit (ASIC), programmable gate array (PGA), discrete digital circuits, etc.) or in a combination of hardware and software (e.g., a software model executed by a corresponding processor).

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term data, however, is not limited to the aforementioned examples and may take various forms and represent any information as understood in the art.

As used herein, a signal that is “indicative of” a value or other information may be a digital or analog signal that encodes or otherwise communicates the value or other information in a manner that can be decoded by and/or cause a responsive action in a component receiving the signal. The signal may be stored or buffered in computer readable storage medium prior to its receipt by the receiving component and the receiving component may retrieve the signal from the storage medium. Further, a “value” that is “indicative of” some quantity, state, or parameter may be physically embodied as a digital signal, an analog signal, or stored bits that encode or otherwise communicate the value.

As used herein, a signal may be transmitted or conducted through a signal chain in which the signal is processed to change characteristics such as phase, amplitude, frequency, and so on. The signal may be referred to as the same signal even as such characteristics are adapted. In general, so long as a signal continues to encode the same information, the signal may be considered as the same signal. For example, a transmit signal may be considered as referring to the transmit signal in baseband, intermediate, and radio frequencies.

While the above descriptions and connected figures may depict device components as separate elements, skilled persons will appreciate the various possibilities to combine or integrate discrete features, functions into a single element. Such may include combining two or more components into a single component. Conversely, skilled persons will recognize the possibility to separate a single element into two or more discrete elements, such as splitting a single component into two or more separate components.

It is appreciated that implementations of methods detailed herein are exemplary in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

While the disclosure has been particularly shown and described with reference to specific embodiments, it should be understood by those skilled in the art that various changes in form and detail may be made therein without departing from the spirit and scope of the disclosure as defined by the appended claims. The scope of the disclosure is thus indicated by the appended claims and all changes which come within the meaning and range of equivalency of the claims are therefore intended to be embraced.

### REFERENCE NUMERAL LIST

100 X-ray detector system 100
110 X-ray source 110
120 X-ray radiation/beams
130 target
140 X-ray detector
142 scintillator/scintillator element
144 photodiode layer
146 substrate
200 X-ray detector system
210 X-ray source
220 X-ray radiation/beams
230 target
235 liquid
240 ultrasound detector array
300 radiation detection system
310 radiation source
320 radiation
330 target
340 radiation detector
350 radiation absorption structure
351 first side of radiation absorption slab/structure
352 radiation absorption slabs/pixel
353 second side of radiation absorption slab/structure
354 higher acoustic impedance material
355 acoustic waves
360 light source
365 optical waveguide
365b branch(es) of optical waveguide
370 photonic integrated circuits/photonic resonator rings
380 light sensor(s)
385 circuitry
390 substrate
395 processing circuitry
400 method
410-430 method steps
500 method
510-560 method steps

1. A radiation detector system comprising:
a radiation absorber structure configured to generate acoustic waves in response to received radiation;
one or more photonic integrated circuits arranged below the radiation absorber structure;
an optical waveguide extending adjacent to the one or more photonic integrated circuits;
a light source configured to emit light into the optical waveguide; and
a plurality of light sensors coupled to the optical waveguide,
wherein the photonic integrated circuits are configured to interfere with light in the optical waveguide in response to receiving acoustic waves from the radiation absorber structure.

2. The radiation detector system of claim 1, further comprising:
a radiation source operable to produce a radiation and toward a first side of the radiation absorber structure.

3. The radiation detector system of claim 2,
wherein the radiation source is an x-ray source configured to produce x-ray beams towards the first side of the radiation absorber structure, and
wherein the radiation absorber structure is configured to generate acoustic waves in response to receiving x-ray radiation produced from the x-ray source.

4. The radiation detector system of claim 1, further comprising:
processing circuitry coupled to the plurality of light sensors and configured to process electrical signals produced by the plurality of light sensors.

5. The radiation detector system of claim 1,
wherein the radiation absorber structure comprises a plurality of radiation absorber slabs.

6. The radiation detector system of claim 5,
wherein the plurality of radiation absorber slabs is separated by a material having an acoustic impedance higher than an acoustic impedance of the radiation absorber slabs.

7. The radiation detector system of claim 5,
wherein the one or more photonic integrated circuits comprise a plurality of photonic integrated circuits.

8. The radiation detector system of claim 7,
wherein each of the plurality of radiation absorber slabs respectively corresponds to one of the plurality of photonic integrated circuits so that for each radiation absorber slab a corresponding photonic integrated circuit is aligned or arranged to be directly below the respective radiation absorber slab.

9. The radiation detector system of claim 7,
wherein for each of the plurality of photonic integrated circuits, a branch of the optical waveguide extends adjacent thereto, each branch including a pair of the plurality of light sensors,
wherein each of the plurality of photonic integrated circuits is configured to interfere with light in the respective branch of the optical waveguide in response to receiving acoustic waves.

10. The radiation detector system of claim 7,
wherein at least one photonic integrated circuit of the plurality of photonic integrated circuits is arranged without any part of the radiation absorber structure arranged directly above the at least one photonic integrated circuit.

11. The radiation detector system of claim 1,
wherein the radiation absorber structure comprises Tungsten.

12. The radiation detector system of claim 1, further comprising:
a substrate, wherein the radiation absorber structure, the light source, and the one or more photonic integrated circuits are disposed on or above the substrate so that a second side of the radiation absorber structure, opposite to a first side, faces the substrate.

13. The radiation detector system of claim 12,
wherein the substrate is a semiconductor substrate.

14. The radiation detector system of claim 13, further comprising:
processing circuitry coupled to the plurality of light sensors and configured to process electrical signals produced by the plurality of light sensors to produce an image of a target.

15. The radiation detector system of claim 14,
wherein the processing circuitry is configured to generate the image of the target comprises the processing circuitry configured to generate a computer tomography (CT) image of the target.

16. The radiation detector system of claim 1,
wherein the light sensors are photo diodes.

17. The radiation detector system of claim 1,
wherein the radiation detector system does not include a scintillator.

18. The radiation detector system of claim 1,
wherein the one or more the photonic integrated circuits comprises one or more photonic resonator rings.

19. A method for forming a radiation detection system, the method comprising:
forming a radiation absorber structure configured to generate acoustic waves in response to the radiation absorber structure receiving radiation;
providing a substrate;
forming one or more photonic integrated circuits on the substrate;
forming an optical waveguide on the substrate to be adjacent to the one or more photonic integrated circuits;
providing a light source so that light source is configured to emit light into the optical waveguide;
arranging the radiation absorber structure above the substrate so that radiation absorber structure so that acoustic waves generated by radiation absorber structure are configured to be detected by the at least one of the one or more photonic integrated circuits.

20. A method comprising:
emitting radiation beams toward a target by a radiation source;
capturing radiation beams by a radiation detector system, wherein the target is positioned between the radiation source and the radiation detector system, the radiation detector system comprising:
a radiation absorber structure configured to generate acoustic waves in response to received radiation;
one or more photonic integrated circuits arranged below the radiation absorber structure;
an optical waveguide extending adjacent to the one or more photonic integrated circuits;
a light source configured to emit light into the optical waveguide; and
a plurality of light sensors coupled to the optical waveguide,
wherein the photonic integrated circuits are configured to optically interfere with light in the optical waveguide in response to receiving acoustic waves from the radiation absorber structure; and
processing electrical signals generated by the light sensors to generate a digital representation of at least a section of the target using processing circuitry coupled to the plurality of light sensors.

21. The method of claim 20, wherein the radiation source comprises an x-ray source configured to produce x-ray beams, and wherein the radiation absorber structure is configured to generate acoustic waves in response to received x-ray radiation.

22. The method of claim 20, wherein processing electrical signals generated by the light sensors to generate a digital representation of at least a section of the target comprises using processing circuitry to generate a computed tomography (CT) image of the target.

23. The method of claim 20, wherein the one or more the photonic integrated circuits comprise one or more photonic resonator rings.
